(19) United States
(12) Patent Application Publication
(10) Pub. No.: US 2005/0247773 A1
(43) Pub. Date: Nov. 10, 2005

(54) Template-based information extraction system and method

(76) Inventors: Jack Hoang, Toronto (CA); Jie Zheng, Toronto (CA)

Correspondence Address: DEETH WILLIAMS WALL LLP, 150 YORK STREET, SUITE 400, TORONTO, M5H 3S5, CA

(21) Appl. No.: 10/839,146

(22) Filed: May 6, 2004

(51) Int. Cl. G06F 17/00; G06F 3/12; G06F 15/12

(52) U.S. Cl. 235/375; 235/432

(57) ABSTRACT

A system and method for extracting and processing text information from a receipt signal generated for output by a printer using a template, comprising the steps of: receiving the template; parsing the receipt signal using the template into at least one receipt information item; and storing the at least one receipt information item into a database.

### TECHNICAL FIELD OF THE INVENTION

This invention is related to a system and method for extracting information from a receipt issued by a point-of-sale machine, an ATM machine, or a card access system, more specifically by parsing such information from the receipt using a template.

### BACKGROUND OF THE INVENTION

Information collected by a point-of-sales terminal (“POS”), such as a cash register, may be of great interest to a merchant operating the POS, whether this information is printed on the receipt or not. The advantage is that the merchant can get more information on the transaction, and it becomes possible to integrate the information from other systems such as a video surveillance system.

Normally, POS or similar machines would have a communication port to connect to a printer. So using a signal splitter, it is conceivably possible to collect the printed receipt information sent to the printer from a POS. Based on the data collected from the communication port, it is possible to analyze the receipt (in electronic format) and extract the information desired for subsequent use.

The main difficulty for this approach lies in the fact that each manufacturer, model, and make may send a receipt in an entirely different layout and style. If it is necessary to design different devices for different models of machine, it is very difficult to adapt to different machines and the maintaining expense will skyrocket because there are thousands of models in the world and new models are introduced perhaps monthly. Thus an ideal solution to this should solve the following two problems:
(1) data collection from different machines; and
(2) a universal information extraction for any models of machine from the data collected.

### SUMMARY OF THE INVENTION

It is an object of this invention to provide a system that can accommodate receipt data extraction and collection from different machines.

In accordance with this objective, this invention discloses a system for processing a receipt contained in a receipt signal generated for output by a printer using a template for the receipt, comprising: an element for receiving the template; an element for parsing the receipt using the template into at least one receipt information item; and storing the at least one receipt information item into a database.

Another embodiment provides a method for processing a receipt contained in a receipt signal generated for output by a printer using a template for the receipt, comprising the steps of: receiving the template; parsing the receipt signal using the template into at least one receipt information item; and storing the at least one receipt information item into a database.

### BRIEF DESCRIPTION OF THE DRAWINGS

FIG. 1 is a block diagram of a system incorporating a preferred embodiment of the present invention;

FIG. 2 shows an example of the plain text representation of a receipt;

FIG. 3 is a flow graph for a preferred embodiment of the invention;

FIG. 4 illustrates the basic template structure;

FIG. 5 is a example of Terminologies Definition Section of a template;

FIG. 6 is an example of a Variable Declaration Section of a template;

FIG. 7 is an example of a Map Definition Section of a template;

FIG. 8 illustrates a sample Receipt Delimiters Section of a template;

FIG. 9 illustrates a receiptstart element with a nested lineor element for a second sample Receipt Delimiters Section of a template;

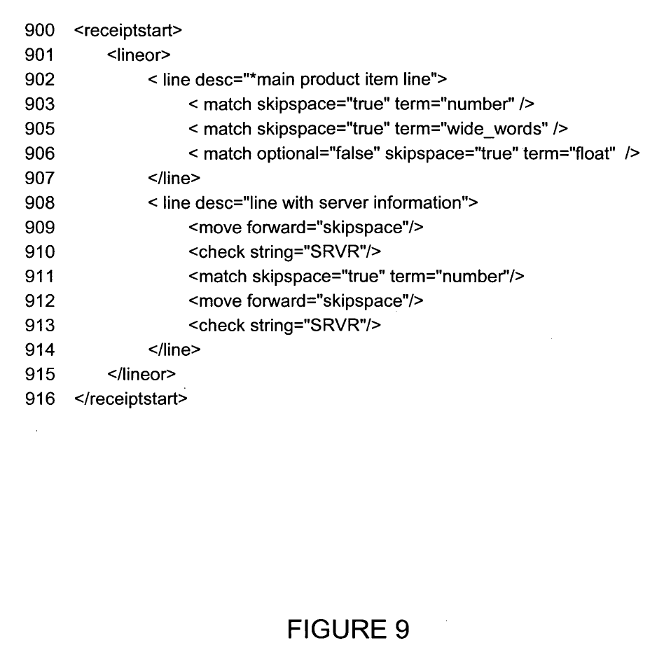

FIG. 10 illustrates a sample Receipt Definition of a template;

FIG. 11 illustrates a sample Receipt Items Definition for the sample Receipt Definition shown in FIG. 10; and

FIG. 12 illustrates a sample Save Procedure Definition Section of a template.

### DETAILED DESCRIPTION OF THE INVENTION

The following will first discuss how to complete the physical collection of data. And then a template-based universal information extraction system will be examined. In this document, POS is used to denote any device which generates a signal sent to a printer for printing, and the output sent to the printer is indicated as the receipt even if the class of such output may be any document which has a fairly standard output style, such as a standard form. The communication protocol is preferably that of a serial communication link (e.g. RS232) or TCP/IP link (e.g. RJ45); however, parallel port communication (e.g. IEEE 1284) is also contemplated.

Introduction

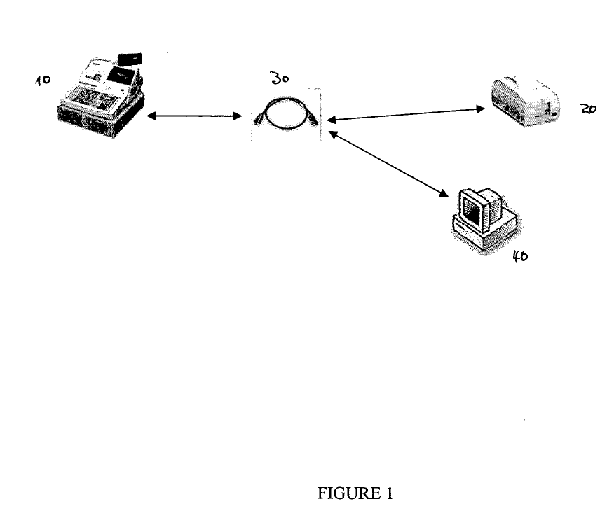

FIG. 1 shows the configuration for a preferred embodiment of the invention. Most POS machines 10 have at least one serial communication port, which is used to connect to a peripheral device 20. Typically, this device is a serial printer 20 for printing hardcopies such as receipts. A serial cable 30 is used for the connection.

In asynchronous serial communication mode, the data is sent in a sequential manner and no synchronization is necessary between the sender and the receiver. (Synchronous transmission is also within this invention, using parallel communication.) It is possible to split the signal sent from the POS 10 down the serial cable 30 with two receivers 20 40 on the other end. If one end is connected to a printer 20 and the other to a device 40 (known in this document as a UIP 40, discussed later) capable of receiving and processing the transmitted data (such as a computer 40), the transmitted print data (receipt signal) may be collected by the UIP device 40 from the POS 10 without interference with its original printing functionality.

FIG. 1 represents a preferred embodiment as well as a conceptualization of alternative possible implementations. For example, the connection between the various components needs not be direct: a network may be interposed between the various elements in the following way. The POS 10 is connected by a serial link to a serial device driver (possibly a computer) which is then connected to a TCP/IP network (such as a LAN or the Internet) with the printer receiving a serial signal from a receiving computer on the TCP/IP network. The UIP device 40 can either receive a raw signal from a signal splitter located anywhere on a serial communication line between the POS 10 and the printer 20 or receive a pre-processed signal from the receiving computer.

The data (receipt signal) collected from the POS 10 for a single receipt are typically composed of 2 components: a plain text component (typically in ASCII), and print formatting control data specific to the printer 20. Preferred embodiments of this invention are denoted in this document as the Universal Information Parser (UIP). Preferred embodiments may be a software system 40 for capturing and processing the receipt data, or a device 40 running such software. This device 40 may be specially built for the required purposes, or it may comprise a general-purpose computer (such as a personal computer), selectively activated or reconfigured by one or more computer programs stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

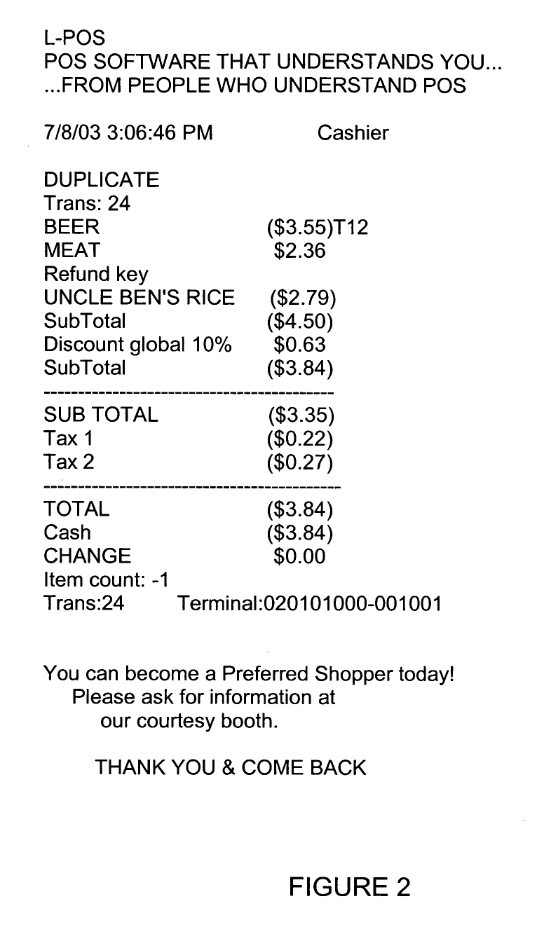

The UIP 40 may include a software (or hardware) pre-processing component to first strip the print format control data from the receipt data. In this way, the plain text of the receipt is isolated, which contains the information needed for subsequent processing. It is clear that prior knowledge of the print format control data for the printer is necessary to be known by the UIP 40 for the plain text to be extracted from a receipt of the printer 20. In this document, a receipt class corresponds to instances of receipts for a particular POS 10 in a particular application for a printer make and model. FIG. 2 shows the plain text content of an instance of a possible receipt for a Logivision POS system 10 in a grocery application.

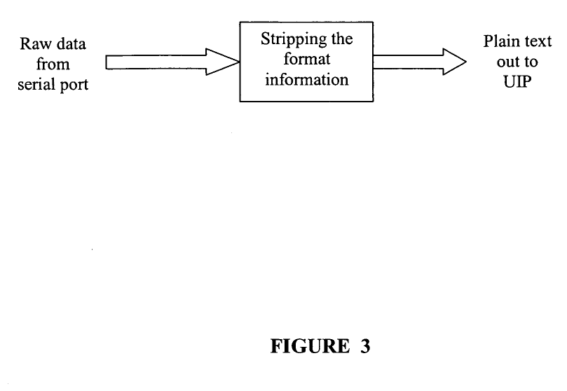

A flow graph is shown in FIG. 3 for a preferred embodiment in the case of a receipt class. A model template describes the constituent elements of the receipt output information: e.g. the Date, Time, Transaction ID, etc. The UIP 40 takes the plain text of the receipt and the corresponding template, and then it retrieves the constituent elements from the plain text in accordance with term of the format description in the template. After UIP 40 obtains such information, it processes the data as also prescribed by the template's content.

Such processing includes in particular storage of relevant information, such as the particulars of the transaction, to a database system. The database system may reside at the device 40 or a different system which communicates by telecommunication elements to the device 40, such as over a wired or wireless network.

Template Generation

The UIP has typically at least 2 input components (a possible further for printer formatting). As discussed above, one component processes receipt templates, and the other specific instances of receipts. Each component performs validation of its input to ensure that the input conforms with what is expected of that input.

For the UIP to analyze a class of receipts from a POS system, it is necessary to perform the following steps:
(1) Determine all the meaningful data items (terms) in the receipts of the receipt class, which also constitute the information to be extracted;
(2) Describe the receipt pattern of the meaningful data items (terms) in a template using a template language. All possible patterns of each such items must be determined and described;
(3) Specify the action to be taken given the information content of the data items of the receipt; and
(4) Input the template to the UIP as the governing template for receipts to be processed.

A template describes the components of a receipt of a particular printer (the receipt class), e.g. the Date, Time, Transaction ID, etc., and the subsequent processing of such information. A template is represented in a template language (known in this document as Universal Receipt Description Markup Language (URDML), a markup language similar to Extensible Markup Language (XML), with templates akin to XML schemas. Using the language descriptive of XML documents, a URDML document, i.e. a template, comprises of a single element (the template element) which contains a number of nested elements. The boundaries of each element are either delimited by start-tags and end-tags, or, for empty elements (no data), by an empty-element tag with a closing />. Each element has a type, identified by name, sometimes called its “generic identifier” (GI), and may have a set of attribute specifications. Each attribute specification has a name and a value with attribute values indicated in quotes. As indicated earlier, elements may be nested. i.e. containing other elements.

Using a template, the UIP 40 can locate and extract such featured data items in the plain text of a receipt data, and then process the data items according to the instructions set out in the template, typically by sending the information to a database system.

Once the UIP 40 has analyzed the template for a receipt class, specific instances of receipts may be submitted to the UIP 40 for information extraction, processing, and storage.

Template Structure

A template for a receipt class comprises preferably of a number of elements (or sections):
(1) Terminologies Definition;
(2) Variable Definition;
(3) Map Definition;
(4) Receipt Delimiters Definition;
(5) Receipt Definition; and
(6) Receipt Items Definition;
(7) Save Procedure Definition.

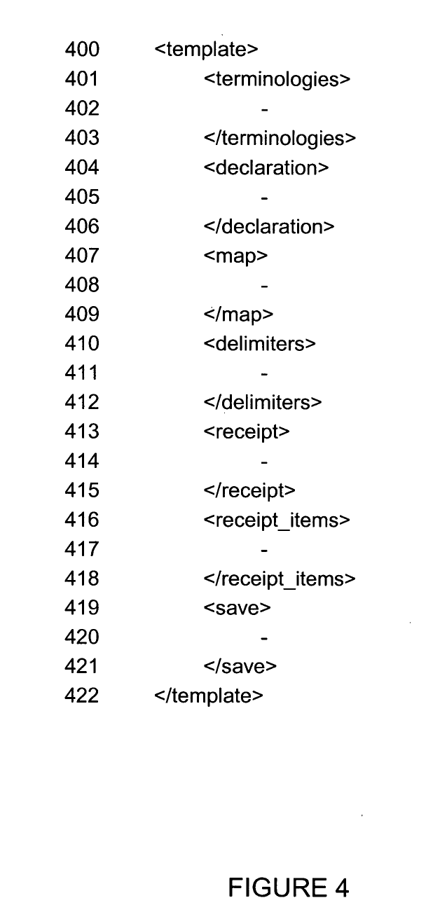

Each element consists of nested elements for defining to the UIP how an instance of a receipt is to be parsed and then processed. The bare skeleton of a template is illustrated in FIG. 4 showing the five sections or elements of a template element. A template may have commented parts. Commented line may be indicated by with an initial semicolon sign (;). These lines are not parsed. It is clear to a person skilled in the art that the order of these sections in a template may be various: the order needs not be as set out above.

(1) Terminologies Definition

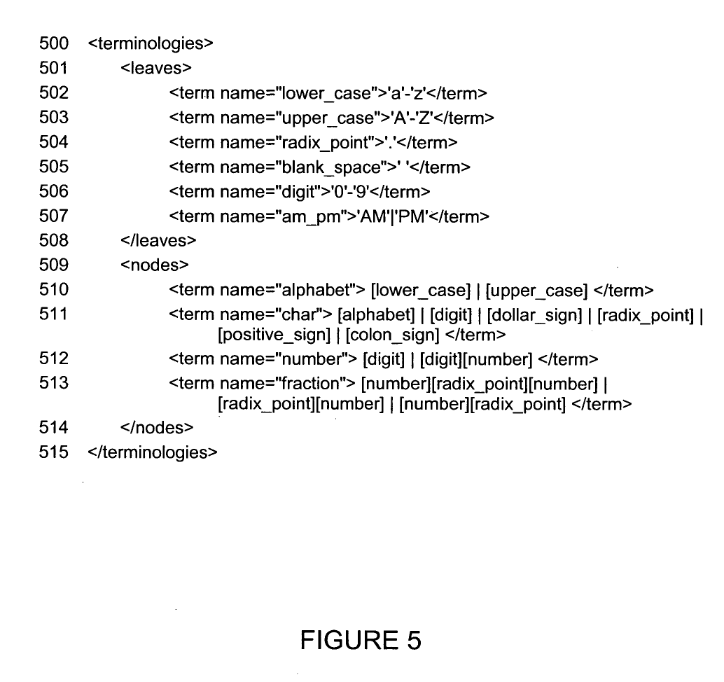

The terminologies element defines all the patterns in which the data items (terms) appear in receipts of the receipt class. FIG. 5 shows a sample Terminology Definition Section (a terminologies element 500-515) delimited by a start tag 500 and an end tag 515. Each pattern is indicated by a term element, which defines at least its name and value. There are primitive patterns (shown as term elements within the leaves element 501-508) lower_case 502, upper_case 503, radix_point 504, blank_space 505, digit and am_pm 506. The patterns of relevant data items in the receipt (alphabet 510, character 511, number 512, fraction 513) are defined, shown as elements within a node element, possibly recursively. The use of 2 separate elements (nodes 509-514 and leaves 501-508) for indicating the two kinds of terminologies is optional (as opposed to a single element).

(2) Variable Definition

This section sets out all the data items (terms) which appear in receipts of the receipt class. Variables are used to contain the information of the data items retrieved; variables may also be used for keeping intermediate results of any subsequent processing and in preparation for later long term storage.

Each variable has preferably an attribute, and its data type. There are typically 2 classes of data types. Firstly, at least 3 simple data types are used: integer, float, and string. These are clear to a person skilled in the art. A data type of the complex data type class is typically either structure or array. A structure data type is defined in the Variable Definition Section as the composition of a finite number of simple and complex items (including possibly another structure of the same type). An array data type refers to a collection of variables of a single data type, which may be a simple or structure data type.

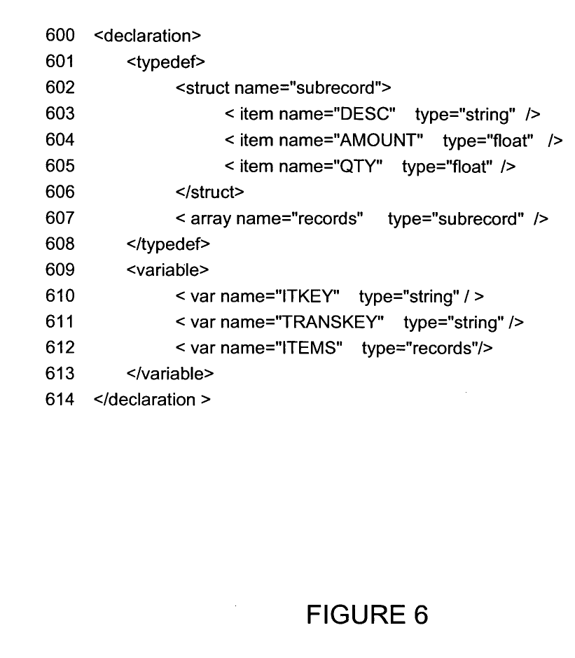

FIG. 6 shows an example of a Variable Definition Section of a template in the form of a declaration element. Two elements are defined in the declaration element. A typedef element (601-608) defines complex variable data types as at least one term element between start and end typedef tags. The actual variable declarations occur in the variable element 609-613. The variable element 609-613 declares 2 complex types: a structure subrecord 602-606 with 3 simple term elements 603-605 and an array records 607. Each item of the records array is of structure data type subrecord. Three (3) variable instances are declared: variables ITKEY 610 and TRANSKEY 611 are of string type; and ITEMS 612 is an array of type records.

(3) Map Definition

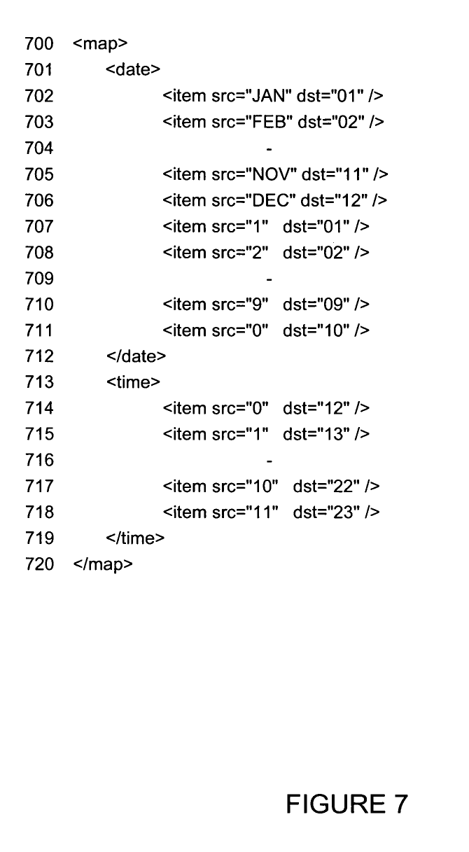

Map element defines patterns in witch data items should be converted. Map element can contain one or more elements witch will be converted with $MAP function. For example, if date presented on receipt in format MMM/dd/YY and in database it is supposed to be in format dd/mm/yy. FIG. 7 shows an example of a Map Definition Section on lines 700 to 720 (some nested item elements of the map element are not shown as indicated by lines 704, 709, and 716).

(4) Receipt Delimiters Definition

Typically, one cannot assume the presence of unique tokens (indicators) in a receipt which demarcate its start and end. It is necessary to determine these by examining the plain text content of the receipt. A Receipt Delimiters section of a template sets out definitions of the transaction start and end patterns. All other plain text may be discarded as not forming relevant parts of the transaction reflected by the receipt.

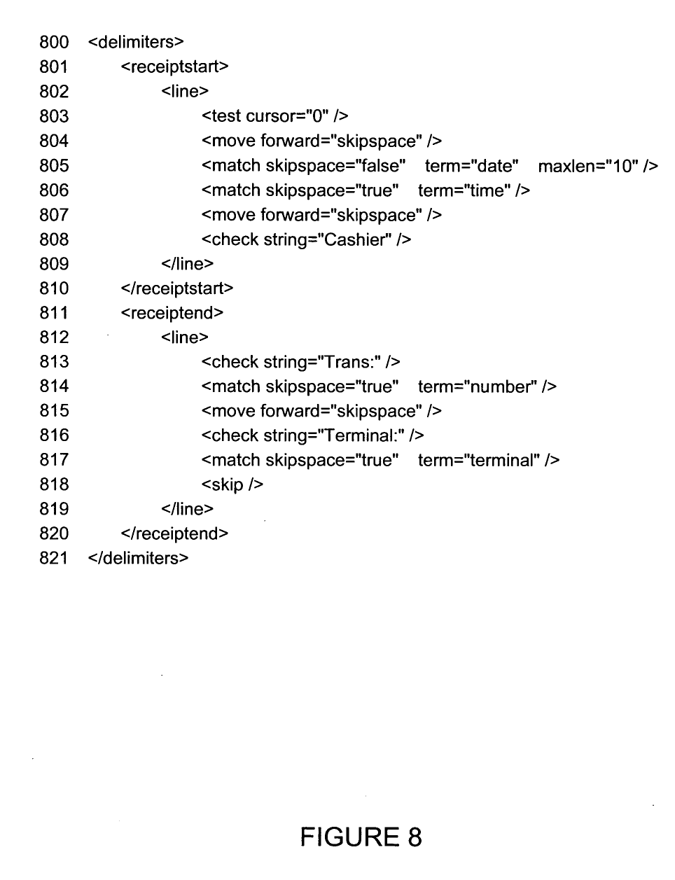

FIG. 8 illustrates a sample Receipt Delimiters section for the receipt shown in FIG. 2. A receiptstart element 801-810 and a receiptend element 811-820 define the components indicating the start and end of a receipt. Further details of the grammar of such statement will be discussed later in this document in the Receipt Definition Section. A single line (802-809) in the receipt is needed to demarcate the start of the receipt in the example of FIG. 8 (more may be possible or needed for other receipt classes). In the example, the receipt start line commences with a date field 805 followed by a time field 806, and then a string “Cashier” 808, all with intervening space(s). Values are assigned to variables for the date and time of the transaction during parsing of a receipt.

In the example shown in FIG. 8, a single line in the receipt is needed to demarcate the end of the receipt. The receipt of FIG. 2 terminates with a transaction number 814 and a terminal number 817, with identifying string “Trans:” 813 and “Terminal:” 816 and intervening space(s). The above assigns values to variables for the transaction number and terminal number during parsing of the receipt.

(5) Receipt Definition

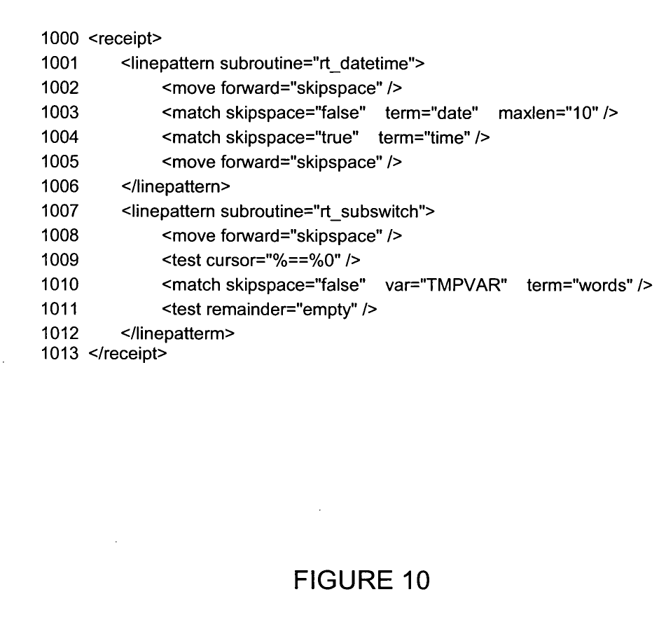

After a single transaction has been identified by locating the start and end delimiters of the corresponding receipt, the UIP proceeds to obtain the values of the relevant data items as defined by the Receipt Definition Section of the template. This part will cause examining of the lines of the receipt line by line, and extract the desired patterns and save to the variables defined in the Variables Definition Section. FIG. 10 shows a example of one possible Receipt Definition Section of a template (as a receipt element) for the receipt of FIG. 2. The subroutines “rt_datetime” and “rt_subswitch” are defined in the Receipt Items Definition Section (discussed below). A subroutine for a linepattern element is executed once the variables are matched as specified in the element.

The template language URDML provides basic programming language features for text processing. At any time during parsing the attention of the parser is focused on the point in the receipt indicated by the position of a virtual cursor. The typically used elements for the receipt section include the following (typical attributes indicated in brackets):

(a) Assignment

Set (VAR VALUE): sets the value of the variable specified by the VAR to that specified by Value.

Operate (VAR1 VAR2 OPER): sets the value of the variable specified by the VAR1 to the result of an OPER operation between VAR1 and VAR2;
For example, the following element increases SUM by the value stored in INCREM:
<operate var1=“SUM” var2=“INCREM” oper=“add” />

(b) Cursor Movement in Receipt

Move (ATTRIBUTE): moves the cursor in the current position of the current line in accordance with ATTRIBUTE; the latter can include Forward, Backward, Search, Cursor, Findstr; and ATTRIBUTE parameter values for forward and backward can be “skipspace” (to skip spaces) or number to tell how many positions forward/backward to move cursor.

Test (CONDN): checks that the current cursor position satisfies the condition specified by CONDN; for example, ‘cursor=“0”’ for the cursor to be at the beginning of the line and “CURSOR=”%>%0”’ for current cursor position other than at the beginning of the line.

Skip: skips the rest of the current line.

(c) Pattern Matching in Receipt

Line (OPTIONAL DESC EXCLUDE FAIL): defines the patterns of a single line; the OPTIONAL attributes indicating whether the line must be matched, DESC is the pattern to be matched; EXCLUDE to indicate checking the line pattern, but leave cursor on the position of the beginning of the line; FAIL to indicate an exit subroutine (with parameter value “exsub”) or exit loop (with parameter value “exloop”).

Linepattern (SUBROUTINE DESC): defines the patterns of a single line; the SUBROUTINE attributes indicating a routine to be invoked when a match is found, DESC is the pattern to be matched, and possibly further parameter for FAIL as with LINE above for exiting a loop or invoking an exit subroutine when a match is not found.

Lineor: defines by setting out two or more LINE elements; only one LINE element is matched.

Check (STRING ): verifies that the cursor is at a position where the ensuing string is indicated by the value for the STRING attribute and moves the cursor to after the string. Other optional parameters may specify checking if there is some defined attribute/term at the cursor position, and whether it is mandatory that the check element is matched match term.

CheckNoMove (STRING): same as Check, except that the cursor is not moved.

Match (SKIPSPACE VAR TERM OUT OPTIONAL): assigns the value of the pattern to the variable specified by the VAR attribute value in the format of the OUT attribute value if the pattern conform to the pattern type specified by the TERM attribute value (and any other defined conditions) after skipping space if the SKIPSPACE value is true. OPTIONAL indicates whether a match must occur.

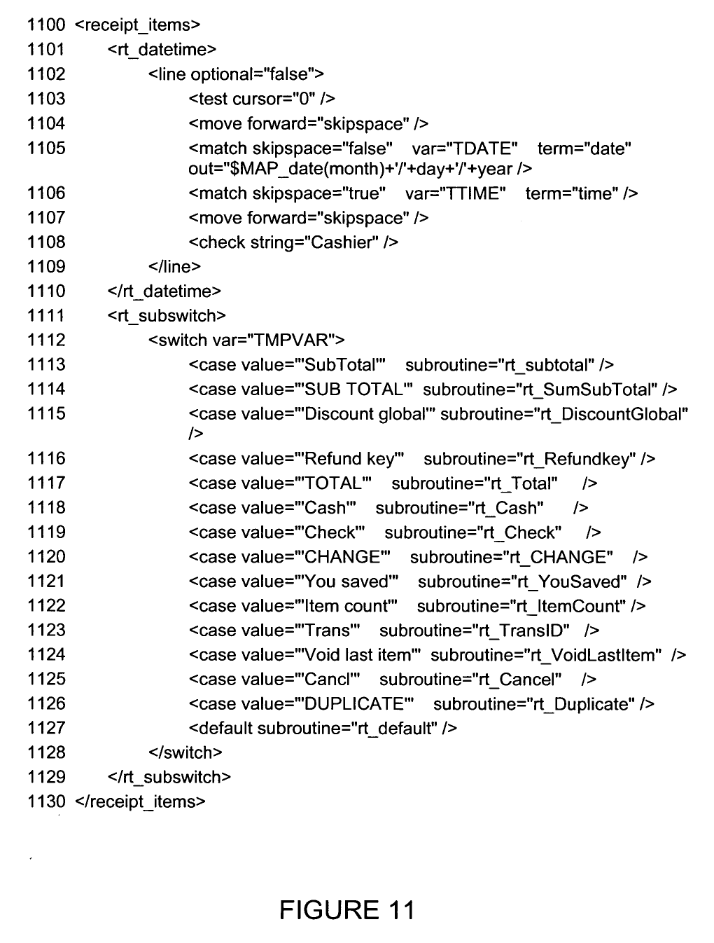

For example, line 1105 of FIG. 11 assigns the value of the string at the position of the cursor without first skipping spaces to the variable TDATE in accordance with the format $MAP_date(month)+‘/’+day+‘/’+year if the string conform with the pattern date.

(d) Flow Control

If (VAR1 VAR2 OPER): defines one or more nested elements to be executed by the parser if a specified condition applies, including a false element containing elements to be executed if the condition is false. The condition is specified by VAR1, VAR2 and OPER.

For example, the following if element forces the cursor to skip the rest of line if the variable end_of_line has value true, otherwise, it attempts to match a date string.

<if var1=“end_of_line” var2=“‘TRUE’” oper=“eq”>

<skip />
<flase>

<match skipspace=“true” term=“date” />

</false>

</if>

Switch (VAR): defines nested case elements to be selectively executed by the parser depending on the value of a specified variable VAR; each case statement specifies a value attribute to be matched with the variable defined by the VAR attribute of the switch element and a subroutine to be called; a default element is executed if the variable could not be matched with any of the case value attribute values; for example, in the example of FIG. 11, a different subroutine 1112-1128 is called for each value of TMPVAR.

Loop: defines elements to be executed when a specified condition is true; the loop may be exited as indicated earlier with LINE or LINEPATTERN statements.

Iterate (VAR ARRAY): contains elements to be executed by the UIP for every element of ARRAY while incrementally increasing the variable specified by VAR;

(e) Subroutines

Callable routines may be defined for various elements, e.g. case and linepattern elements. Each subroutine is an element with a unique generic identifier.

In addition to the above, URDML provides for native functions, especially for text processing. For example, $MAP is a function for converting string. The definition of converting string is in the Map Definition Section of the template (discussed above). $ECHO refers to a function retrieving values from environment variables. It is clear to a person skilled in the art what additional functions are needed and can be implemented.

(6) Receipt Items Definition

The Receipt_items Definition Section defines subroutines for the template, in particular for the elements linepattern and line. This section is noted by the item receipt items. An example is shown in FIG. 11 in relation to the receipt definition of FIG. 10.

Some of the URDML language components discussed for the Receipt Definition Section above may also be used in the subroutines of the Receipt Items Definition Section.

(7) Save Procedure Definition

The extraction of the relevant information from the receipt results ultimately in their content (or processed versions) being stored in a long term storage for later access and processing. The Save Procedure Definition Section defines the steps for storage of information to one or more databases. Further to the element types of the Receipt Definition Section, language elements of the Save Procedure Definition Section include the following:

Create (KEY TIME DATE): generates a key value, and store current (DVR) time and date.

Insunique (TABLE): inserts a record into database table TABLE with a record using unique values specified by nested update elements.

Insert (TABLE): inserts a record into the database table TABLE with record field values specified by nested update elements;

Update (FIELD, VALUE): specified the field (specified by attribute FIELD) value (specified by attribute VALUE) of the record to be inserted in the enclosing insunique or insert element.

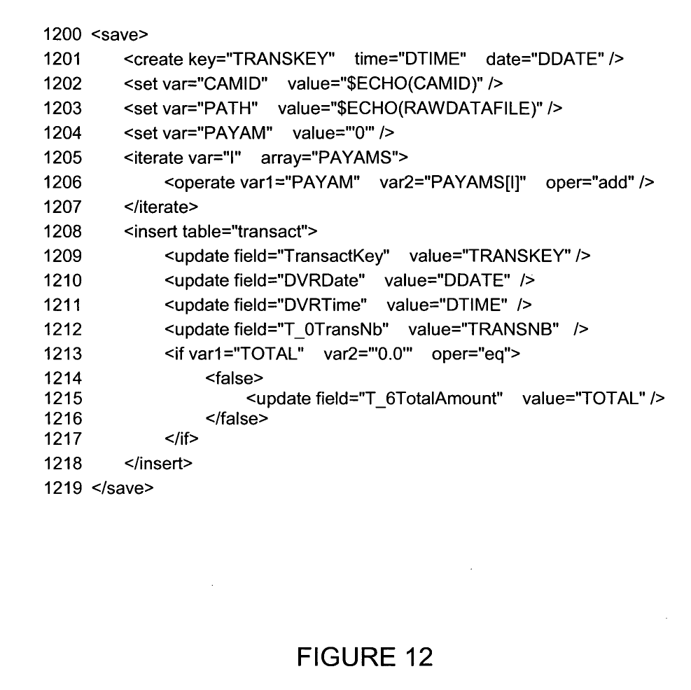

For example, in lines 1208-1218 of FIG. 12, a record is saved to the transact database table, with updated record fields TransactKey, DVRDate, DVRTime, T_{—}0TransNb, and possible T_{—}6TotalAmount.

Further element types may be added to the language. For example, an element for specifying external namespaces may augment the syntactical range of the language.

To this point, all the relevant information has been extracted from the receipt and after possible processing saved to the database (or a portion thereof). This stored information may be made a part of a knowledge mining system text, which can be widely used in POS, ATM, and Card Access Systems.

The environment accessible to a URDML document as described is limited in the sense that input is restricted to a plain text stream (receipt document) and output is to one or more database tables, which are all under the control of the UIP 40 parsing and executing the URDML document. Typically, the UIP 40 is programmable to direct output to a number and variety of destinations. For example, the tables may not be of the same database system.

Reference has been made in this document to the extensible markup language (XML). XML is an evolving language. The XML specification and related material may be found at the website of the World Wide Web Consortium (W3C).

It will be appreciated that the above description relates to the preferred embodiments by way of example only. Many variations on the system and methods for delivering the invention will be clear to those knowledgeable in the field, and such variations are within the scope of the invention as described and claimed, whether or not expressly described.

1. A system for processing a receipt contained in a receipt signal generated for output by a printer using a template for the receipt, comprising:
an element for receiving the template;
an element for parsing the receipt using the template into at least one receipt information item; and
storing the at least one receipt information item into a database.

2. The system of claim 1, further comprising an element for receiving the receipt signal.

3. The system of claim 1, further comprising an signal splitting element for receiving the receipt signal transmitted from a device to the printer, the device being selected from the group comprising a point-of-sales machine (POS), an automated teller machine, and a card-access machine.

4. The system of claim 1, wherein the receipt signal comprises a text component and a print formatting component, and the system comprises an element for extracting the text component for subsequent parsing.

5. The system of claim 1, wherein the template is a URDML document.

6. The system of claim 1, wherein the template describes constitutive elements of the receipt, and the template contains instructions for processing and storing in the database of specific elements of the receipt.

7. The system of claim 6, wherein for describing constitutive elements of the receipt the template sets out the delimiters of the receipt, and the pattern of the receipt on a line-by-line basis.

8. A method for processing a receipt contained in a receipt signal generated for output by a printer using a template for the receipt, comprising the steps of:
receiving the template;
parsing the receipt signal using the template into at least one receipt information item; and
storing the at least one receipt information item into a database.

9. The method of claim 8, further comprising receiving the receipt signal prior to parsing the receipt signal.

10. The method of claim 8, further receiving the receipt signal transmitted from a device to the printer, the device being selected from the group comprising a point-of-sales machine (POS), an automated teller machine, and a card-access machine.

11. The method of claim 8, wherein the receipt signal comprises a text component and a print formatting component, and the system comprises an element for extracting the text component for subsequent parsing.

12. The method of claim 8, wherein the template is a URDML document.

13. The method of claim 8, wherein the template describes constitutive elements of the receipt, and the template contains instructions for processing and storing in the database of specific elements of the receipt.

14. The method of claim 13, wherein for describing constitutive elements of the receipt the template sets out the delimiters of the receipt, and the pattern of the receipt on a line-by-line basis.

15. A computer readable medium encoded with instructions for directing a processor to: perform the method of claim 8.
